(19) United States
(12) Patent Application Publication
(10) Pub. No.: US 2026/0018763 A1
(43) Pub. Date: Jan. 15, 2026

(54) SECONDARY BATTERY AND METHOD FOR MANUFACTURING SECONDARY BATTERY

(71) Applicant: SAMSUNG SDI CO., LTD., Yongin-si (KR)

(72) Inventors: Hiroshi Seino, Yongin-si (KR); Jeongchull AHN, Yongin-si (KR); Sanghyun KIM, Yongin-si (KR); Sunyang HONG, Yongin-si (KR)

(21) Appl. No.: 19/235,418

(22) Filed: Jun. 11, 2025

(30) Foreign Application Priority Data
Jul. 11, 2024 (KR) 10-2024-0091493

(51) Int. Cl. H01M 50/586; H01M 50/403; H01M 50/426; H01M 50/434; H01M 50/446; H01M 50/457; H01M 50/463; H01M 50/489

(52) U.S. Cl. CPC H01M 50/586; H01M 50/403; H01M 50/426; H01M 50/434; H01M 50/446; H01M 50/457; H01M 50/463; H01M 50/489

(57) ABSTRACT

A secondary battery may comprise an electrode assembly, a case that accommodates the electrode assembly and a swelling member between the electrode assembly and the case. The swelling member may fill a peripheral space between the case and the electrode assembly within the case, and comprise a first swelling layer capable of swelling by impregnation with electrolyte.

### CROSS REFERENCE TO RELATED APPLICATION

The present application claims priority to and the benefit of Korean Application No. 10-2024-0091493, filed on Jul. 11, 2024, in the Korean Intellectual Property Office, the entire content of which is hereby incorporated by reference.

### BACKGROUND

### 1. Field

The subject matter of the present disclosure relates to a secondary battery including a swelling member.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Where a secondary battery is used continuously or exposed to extreme conditions, a positive electrode and a negative electrode may be more susceptible to electrical contact. If two materials having different polarities in a secondary cell come into electrical contact, an internal short circuit may occur. An internal short circuit may quickly increase the temperature of the secondary cell and, in severe cases, may lead to a fire.

The above information disclosed in this Background section is for enhancement of understanding of the background of the present disclosure, and therefore, it may contain information that does not constitute related (or prior) art.

### SUMMARY

Embodiments of the present disclosure provide a secondary battery that addresses the problems described above.

These and other aspects and features of the present disclosure will be described in or will be apparent from the following description of embodiments of the present disclosure.

According to embodiments of the present disclosure for realizing at least one of the above-described objectives, a secondary battery includes: an electrode assembly; a case that accommodates the electrode assembly; and a swelling member between the electrode assembly and the case, wherein the swelling member fills a peripheral space between the case and the electrode assembly within the case, and includes a first swelling layer capable of swelling by impregnation with electrolyte.

According to embodiments of the present disclosure, the electrode assembly may include an electrode tab provided on a first side of the electrode assembly and connected to an electrode of the electrode assembly, a first side surface of the case may be connected to the electrode tab, and the swelling member may be between the first side of the electrode assembly and the first side surface of the case.

According to embodiments of the present disclosure, the swelling member may insulate (e.g., electrically insulate) between the electrode tab and the electrode assembly and/or between the electrode assembly and the case.

According to embodiments of the present disclosure, the swelling member may expand by 5% to 50% in volume after the impregnation with electrolyte (e.g., compared to a volume of the swelling member before the impregnation with the electrolyte).

According to embodiments of the present disclosure, the swelling member may expand by 5% or more in thickness after impregnation with the electrolyte (e.g., compared to a thickness of the swelling member before impregnation with the electrolyte).

According to embodiments of the present disclosure, the first swelling layer may include at least one of a fluorine-based resin or a urethane-based resin.

According to embodiments of the present disclosure, the fluorine-based resin may include a polyvinylidene difluoride (PVDF) copolymer.

According to embodiments of the present disclosure, the PVDF copolymer may include at least one of polyvinylidene difluoride-hexafluoropropylene (PVDF-HFP), polyvinylidene difluoride-perfluoroalkoxy (PVDF-PFA), polyvinylidene difluoride-chlorotrifluoroethylene (PVDF-CTFE), or polyvinylidene difluoride-tetrafluoroethylene (PVDF-TFE).

According to embodiments of the present disclosure, the first swelling layer may further include an additive having heat-absorbing properties.

According to embodiments of the present disclosure, the additive may include at least one of aluminum oxide (Al₂O₃) or boehmite.

According to embodiments of the present disclosure, the first swelling layer may further include particulates including an acrylic-based resin.

According to embodiments of the present disclosure, the swelling member may further include an adhesive layer on a first surface of the first swelling layer, and the swelling member may be bonded to at least one of the electrode assembly or the case by the adhesive layer.

According to embodiments of the present disclosure, the swelling member may further include an insulating sheet (e.g., an electrically insulating sheet) on a first surface of the first swelling layer, and the insulating sheet may include at least one of polyethylene terephthalate (PET), polybutylene terephthalate (PBT), polyimide (PI), or polyether ether ketone (PEEK).

According to embodiments of the present disclosure, the first swelling layer may be on a first surface of the insulating sheet, and the swelling member may further include a second swelling layer on a second surface of the insulating sheet opposite (e.g., facing away from) the first surface of the insulating sheet.

According to embodiments of the present disclosure, the swelling member may have a corrugated shape.

According to embodiments of the present disclosure for realizing at least one of the above-described objectives, a method of manufacturing a secondary battery includes: preparing an electrode assembly; accommodating the electrode assembly in a case; and providing a swelling member between the electrode assembly and the case, wherein the swelling member fills a peripheral space between the case and the electrode assembly within the case, and includes a first swelling layer capable of swelling by impregnation with electrolyte.

According to embodiments of the present disclosure, method may further include injecting an electrolyte into the case so that the swelling member is impregnated with the electrolyte and is caused to swell.

According to embodiments of the present disclosure, the swelling member may expand by 5% or more in thickness after the impregnation with electrolyte (e.g., compared to a thickness of the swelling member before the impregnation with the electrolyte).

According to embodiments of the present disclosure, the swelling member may further include an insulating sheet (e.g., an electrically insulating sheet) on a first surface of the first swelling layer, and the insulating sheet includes at least one of polyethylene terephthalate (PET), polybutylene terephthalate (PBT), polyimide (PI), or polyether ether ketone (PEEK).

According to embodiments of the present disclosure, the first swelling layer may be on a first surface of the insulating sheet, and the swelling member further includes a second swelling layer on a second surface of the insulating sheet opposite (e.g., facing away from) the first surface of the insulating sheet.

According to various embodiments of the present disclosure, the swelling member may insulate (e.g., electrically insulate) between the electrode tab and the electrode assembly and/or between the electrode assembly and the case. In embodiments, the swelling member may prevent (or reduce a likelihood, occurrence, or degree of) short circuits between components of the secondary battery.

According to various embodiments of the present disclosure, the swelling member expanded by impregnation with electrolyte may further fill the peripheral space between the electrode assembly and the case. As a result, the electrode assembly may not move within the case. In embodiments, even if the case is impacted from the outside or the secondary battery is dropped, the expanded swelling member may protect the electrode assembly from the external impact. For example, the swelling member may protect the components within the secondary battery, thereby increasing the safety of the secondary battery including the swelling member.

According to various embodiments of the present disclosure, the swelling member including the urethane-based resin may effectively fill the peripheral space between the case and the electrode assembly with ridges and furrows of the corrugated structure even if the peripheral space is not uniformly spaced.

According to various embodiments of the present disclosure, the additive contained in the swelling layer may absorb heat and suppress thermal runaway (or may reduce a likelihood, occurrence, or degree of thermal runaway).

According to various embodiments of the present disclosure, where the swelling layer includes an acrylic-based resin together with a urethane-based resin and/or a fluorine-based resin, the swelling layer may further swell by being impregnated with an electrolyte

According to various embodiments of the present disclosure, because the swelling layer includes a pigment, verification of the arrangement of the swelling member, identification of defects in the manufacturing process of the secondary battery, and/or the like may be performed without disassembling the secondary battery

According to various embodiments of the present disclosure, the swelling member may be fixed inside the secondary battery by the adhesive layer.

According to various embodiments of the present disclosure, because the swelling member includes the insulating sheet, the swelling member may have various suitable levels of strength/stiffness depending on the configuration environment of the secondary battery.

According to various embodiments of the present disclosure, the secondary battery including the swelling member may be determined to be safe for drops.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is an outline view showing a secondary battery according to embodiments of the present disclosure;

FIG. 2 is a cross-sectional view showing the secondary battery according to embodiments of the present disclosure;

FIG. 3 is a cross-sectional view of an example of a swelling member according to a first embodiment of the present disclosure;

FIG. 4 is a cross-sectional view of an example of a swelling member according to a second embodiment of the present disclosure;

FIG. 5 is a cross-sectional view of an example of a swelling member according to a third embodiment of the present disclosure;

FIG. 6 is a cross-sectional view of an example of a swelling member according to a fourth embodiment of the present disclosure;

FIG. 7 is a cross-sectional view of an example of a swelling member according to a fifth embodiment of the present disclosure;

FIG. 8 is a diagram showing example shapes of the swelling member according to embodiments of the present disclosure before and after being impregnated with electrolyte; and

FIG. 9 is a flowchart showing an example of a method of manufacturing a secondary battery according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

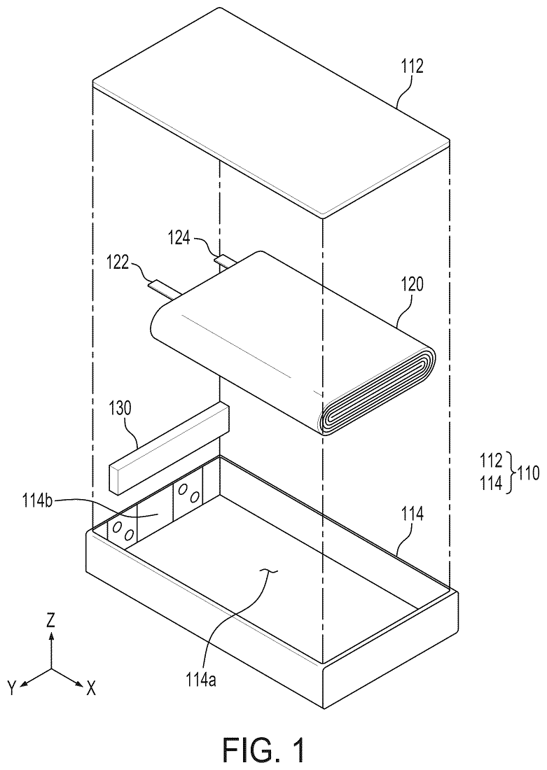

FIG. 1 is an outline view showing a secondary battery according to embodiments of the present disclosure. Referring to FIG. 1, a secondary battery may include a case 110, an electrode assembly 120, and a swelling member 130.

Referring to FIG. 1, the secondary battery may be a prismatic or pouch secondary battery. However, the shape of the secondary battery is not limited thereto, and the secondary battery may be a cylindrical secondary battery, a button secondary battery, or the like.

The electrode assembly 120 may include a first electrode, a second electrode, and a separator. The separator may be provided between the first electrode and the second electrode. The electrode assembly 120 may be constructed by winding or stacking the first electrode, the second electrode, and the separator. Referring to FIG. 1, the electrode assembly 120 is shown as being of a wound type (e.g., a wound kind of electrode assembly), but the shape of the electrode assembly 120 is not limited thereto and may be, for example, a stacked type (or kind) or another shape.

The first electrode may be configured such that a first active material layer is on at least a portion of a first substrate. A first electrode tab 122 may extend outwardly from a first uncoated portion of the first substrate where the first active material layer is not provided, and the first electrode tab 122 may be electrically connected to the case 110 (e.g., a first terminal included in the case 110).

The second electrode may be configured such that a second active material layer is on at least a portion of a second substrate. A second electrode tab 124 may extend outwardly from a second uncoated portion of the second substrate where the second active material layer is not provided, and the second electrode tab 124 may be electrically connected to the case 110 (e.g., a second terminal included in the case 110). Referring to FIG. 1, the first electrode tab 122 and the second electrode tab 124 may extend in the same direction from the first electrode and the second electrode, respectively, such that the first electrode tab 122 and the second electrode tab 124 are on a first side of the electrode assembly 120. However, the foregoing is not intended to be limiting, and the first electrode tab 122 of the first electrode may be on the first side of the electrode assembly 120, and the second electrode tab 124 of the second electrode may be on a second side of the electrode assembly 120.

The first electrode tab 122 and the second electrode tab 124 on the first side of the electrode assembly 120 may be directly connected to the case 110. However, the manner in which the electrode tabs 122 and 124 of the electrode assembly 120 are connected to the case 110 is not limited thereto. For example, each of the first electrode tab 122 and the second electrode tab 124 may be connected to the case 110 by forming a lead tab, or may be connected to the case 110 by using a strip terminal.

The first electrode may function as a positive electrode. In some embodiments, the first substrate may include, for example, aluminum foil, and the first active material layer may include, for example, a transition metal oxide. The second electrode may function as a negative electrode. In some embodiments, the second substrate may include, for example, copper foil and/or nickel foil, and the second active material layer may include, for example, graphite.

The separator may function to prevent short-circuiting of the first and second electrodes (or reduce a likelihood, occurrence, or degree of a short-circuit) while allowing lithium ions to migrate. The separator may include, for example, but is not limited to, a polyethylene film, a polypropylene film, a polyethylene-polypropylene film, and/or the like.

The case 110 may accommodate the electrode assembly 120 and electrolyte, and form a contour of the secondary battery. For example, the case 110 may include a receiving portion 114 configured to receive the electrode assembly 120 and a cover plate 112 configured to enclose the receiving portion 114. However, the shape of the case 110 is not limited thereto, and the case 110 may be configured in a variety of suitable shapes, such as a circular shape (e.g., a generally circular shape), a coin shape, and/or the like. The case may also be formed of a metal, such as stainless steel (SUS), aluminum, an aluminum alloy, nickel-plated steel, a laminated film and/or plastic of which a pouch is formed of, and/or the like.

Referring to FIG. 1, an electrode assembly 120 may be inserted through an opening 114a provided in a first side of the receiving portion 114 of the case 110, and the opening 114a of the receiving portion 114 may be sealed with a cover plate 112. Thereafter, the joining portions of the receiving portion 114 and the cover plate 112 may be joined by, for example welding.

In one embodiment, a first terminal may be on a first side surface 114b of the receptacle 114. In some embodiments, a second terminal may be further on the first side surface 114b of the receptacle 114. The first electrode tab 122 of the electrode assembly 120 inserted into the receptacle 114 may be electrically connected to the first terminal. In some embodiments, the second electrode tab 124 of the electrode assembly 120 inserted into the receptacle 114 may be electrically connected to the second terminal. However, the foregoing is not intended to be limiting, and the second terminal may be on a second side surface of the receptacle 114 or on the cover plate 112. In another example, the second terminal may not be provided separately on the receptacle 114, and the second electrode tab 124 may be electrically connected to the case 110.

The swelling member 130 may be between the electrode assembly 120 and the case 110. The swelling member 130 may fill a peripheral space within the case 110 between the case 110 and the electrode assembly 120. The swelling member 130 may include a swelling layer capable of swelling by impregnation with electrolyte.

In one or more embodiments, the first side surface 114b of the receiving portion 114 may be connected to the electrode tabs 122 and 124 of the electrode assembly 120. The electrode tabs 122 and 124 may be on the first side of the electrode assembly 120. In some embodiments, the swelling member 130 may be between the first side of the electrode assembly 120 and the first side surface 114b of the receiving portion. However, the position and/or area within the case 110 where the swelling member 130 is provided is not limited. For example, in embodiments where the first side of the cover plate 112 and the electrode tabs 122 and 124 are connected, the swelling member 130 may be between the first side of the electrode assembly 120 and the first side of the cover plate 112.

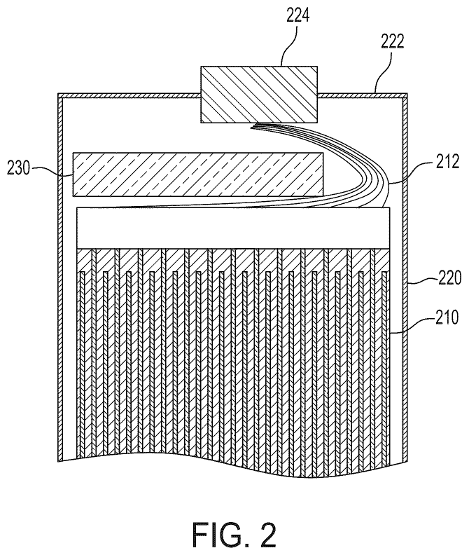

FIG. 2 illustrates a cross-sectional view showing the secondary battery according to embodiments of the present disclosure. FIG. 2 illustrates a cross-sectional view showing the structure of a substantially square secondary battery cut on a line intersecting a first side surface of a case 220 connected to the electrode tab. In the secondary battery shown in FIG. 2, the components of the secondary battery described with reference to FIG. 1 may be shown as being coupled together. Each of an electrode assembly 210 and the case 220 described with reference to FIG. 2 may be substantially the same as the corresponding components of the secondary battery described with reference to FIG. 1. With reference to FIG. 2, the configuration of a swelling member 230 will be mainly described.

The swelling member 230 may be between the electrode assembly 210 and the case 220. The swelling member 230 may fill a peripheral space within the case 220 between the case 220 and the electrode assembly 210. Referring to FIG. 2, a first side surface 222 of the case may be connected to an electrode tab 212 on a first side of the electrode assembly 210. In some embodiments, the swelling member 230 may be between the first side surface 222 of the case and a first side of the electrode assembly 210.

In one embodiment, the first side surface 222 of the case connected to the electrode tab 212 may include an electrode terminal 224. In some embodiments, the electrode terminal 224 may be connected to the electrode tab 212. In some embodiments, the electrode terminal 224 and the electrode connected to the electrode tab 212 may be electrically connected.

Referring to FIG. 2, the electrode tab 212 may be bent in the space between the first side surface 222 of the case and the electrode assembly 210 so as to be received within the case 220. In some embodiments, at least a portion of the swelling member 230 may be wrapped in the bent electrode tab 212 (e.g., may be at least partially surrounded by the bent electrode tab 212). In one or more embodiments where the electrode tab 212 is connected to the first side surface 222 of the case using a separate component (e.g., a strip terminal), the swelling member 230 may be between that component and the electrode tab 212. However, the position and/or arrangement of the swelling member 230 within the case 220 is not limited. For example, a plurality of swelling members 230 may be provided in the free space between the case 220 and the electrode assembly 210 to fill the peripheral space of the electrode assembly 210. In another example, the swelling member 230 may be between the case 220 and a second side of the electrode assembly 210 opposite (e.g., facing away from) the first side of the electrode assembly 210 on which the electrode tab 212 is formed.

The swelling member 230 may include an insulating material (e.g., an electrically insulating material). Herein, the insulating material may include a material having properties that provide electrical insulation to prevent current from passing therethrough (or to reduce an amount of current that passes therethrough). Accordingly, the swelling member 230 may insulate (e.g., electrically insulate) between the electrode tab 212 and the electrode assembly 210 and/or between the electrode assembly 210 and the case 222. In some embodiments, the swelling member 230 may prevent short circuits (or reduce a likelihood, occurrence, or degree of short circuits) between the components included in the secondary battery.

The swelling member 230 may be impregnated with an electrolyte after filling the peripheral space between the case 220 and the electrode assembly 210. The swelling member 230 may include a swelling layer capable of swelling by impregnation with the electrolyte. After the electrolyte is injected into the case 220 in which the electrode assembly 210 and the swelling member 230 are accommodated, the swelling member 230 may swell by impregnation with the electrolyte. The expanded swelling member 230 may further fill the peripheral space between the electrode assembly 210 and the case 220. As a result, the electrode assembly 210 may not flow within the case 220. In some embodiments, even if the case 220 is impacted from the outside or the secondary battery is dropped, the expanded swelling member 230 may protect the electrode assembly 210 from the external impact. For example, the swelling member 230 may protect the components within the secondary battery, thereby increasing the safety of the secondary battery including the swelling member 230.

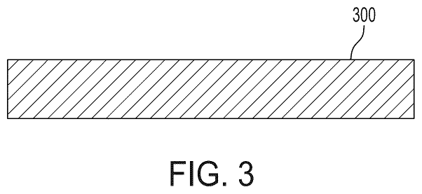

FIG. 3 illustrates an example of a swelling member 300 according to a first embodiment of the present disclosure. The swelling member 300 may include a swelling layer capable of swelling by impregnation with electrolyte. The swelling layer may include at least one of a fluorine-based resin or a urethane-based resin. For example, the fluorinated resin may include a polyvinylidene difluoride (PVDF) copolymer. For example, the PVDF copolymer may include at least one of polyvinylidene difluoride-hexafluoropropylene (PVDF-HFP), polyvinylidene difluoride-perfluoroalkoxy (PVDF-PFA), polyvinylidene difluoride-chlorotrifluoroethylene (PVDF-CTFE), or polyvinylidene difluoride-tetrafluoroethylene (PVDF-TFE). Herein, the fluorine-based resin, when swollen by impregnation with the electrolyte, may tend to swell uniformly (e.g., substantially uniformly) in all three dimensions of the X, Y, and Z directions. As a result, the swelling member 300 including the fluoroplastic resin may effectively fill the peripheral space between the case and the electrode assembly.

In one or more embodiments, the swelling member 300 may have a corrugated structure. For example, the urethane-based resin, when swollen by impregnation with the electrolyte, may tend to swell in the thickness direction. Accordingly, the swelling member 300 including the urethane-based resin may effectively fill the peripheral space between the case and the electrode assembly with ridges and furrows of the corrugated structure even if the peripheral space is not uniformly spaced.

In one embodiment, the swelling layer of the swelling member 300 may further include an additive having heat-absorbing properties. For example, the additive may include at least one of aluminum oxide (Al₂O₃) or boehmite. The additive contained in the swelling layer may absorb heat generated by the secondary battery. For example, if a short circuit occurs in the secondary battery, the secondary battery may experience thermal runaway. In some embodiments, the additive contained in the swelling layer may absorb the heat and suppress the thermal runaway (or reduce a likelihood, occurrence, or degree of thermal runaway).

In one or more embodiments, the swelling layer may further include particulates including an acrylic-based resin. In embodiments where the swelling layer includes particulates including an acrylic-based resin together with a urethane-based resin and/or a fluorine-based resin, the swelling layer may further swell by being impregnated with an electrolyte.

In one or more embodiments, the swelling layer may further include a pigment. Due to the pigment contained in the swelling layer, the swelling member 300 may be identified by a sensor and/or the like provided outside the secondary battery. In some embodiments, verification of the arrangement of the swelling member 300, identification of defects in the manufacturing process of the secondary battery, and/or the like may be performed without disassembling the secondary battery.

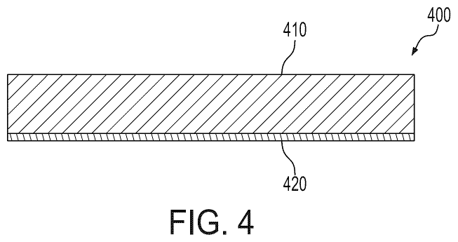

FIG. 4 illustrates an example of a swelling member 400 according to a second embodiment of the present disclosure. The swelling member 400 capable of swelling by impregnation with electrolyte may include a swelling layer 410 and an adhesive layer 420. The swelling layer 410 may be substantially the same as the swelling layer described with reference to FIG. 3. With reference to FIG. 4, the adhesive layer 420 will be mainly described.

The adhesive layer 420 may be on a first surface of the swelling layer 410. By the adhesive layer 420, the swelling member 400 may be bonded to at least one of the electrode assembly or the case within the secondary battery. However, the foregoing is not intended to be limiting, and the swelling member 400 may be bonded to at least any suitable one of the components inside the secondary battery. As a result, the swelling member 400 may be fixed inside the secondary battery.

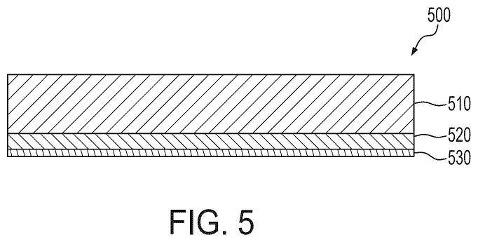

FIG. 5 illustrates an example of a swelling member 500 according to a third embodiment of the present disclosure. The swelling member 500 may include a swelling layer 510 capable of swelling by impregnation with electrolyte, an insulating sheet 520 (e.g., an electrically insulating sheet 520), and an adhesive layer 530. The swelling layer 510 may be substantially the same as the swelling layer described with reference to FIG. 3. In FIG. 5, the insulating sheet 520 and the adhesive layer 530 will be mainly described.

The insulating sheet 520 may be on a first surface of the swelling layer 510. The insulating sheet 520 may include an insulating material (e.g., an electrically insulating material). For example, the insulating sheet 520 may include at least one of polyethylene terephthalate (PET), polybutylene terephthalate (PBT), polyimide (PI), or polyether ether ketone (PEEK). The insulating sheet 520 including any of the materials described above may be stiffer than the swelling layer 510. As a result, the swelling member 500 may have various suitable levels of strength/stiffness depending on the configuration environment of the secondary battery.

Referring to FIG. 5, the adhesive layer 530 may be on the first surface of the insulating sheet 520. For example, the adhesive layer 530 may include an acrylic-based adhesive. However, the foregoing is not intended to be limiting, the adhesive layer 530 may be on a second surface of the swelling layer 510 opposite (e.g., facing away from) the first surface of the swelling layer 510 on which the insulating sheet 520 is provided. In another example, the adhesive layer 530 may be on side surfaces of the swelling layer 510 and the insulating sheet 520.

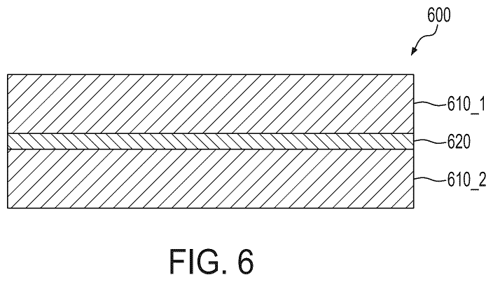

FIG. 6 illustrates an example of a swelling member 600 according to a fourth embodiment of the present disclosure. The swelling member 600 may include a first swelling layer 610_1 capable of swelling by impregnation with electrolyte, an insulating sheet 620 (e.g., an electrically insulating sheet 620), and a second swelling layer 610_2 capable of swelling by impregnation with electrolyte. The respective swelling layers 610_1 and 610_2 may be substantially the same as the swelling layer described with reference to FIG. 3. The insulating sheet 620 may be substantially the same as the insulating sheet 520 described with reference to FIG. 5. FIG. 6 focuses on the structure of the first swelling layer 610_1, the insulating sheet 620, and the second swelling layer 610_2 included in the swelling member 600, which differs from the above description.

In one embodiment, the insulating sheet 620 may be on a first surface of the first swelling layer 610_1. A first surface of the insulating sheet 620 may face the first swelling layer 610_1. The second swelling layer 620_2 may be on a second surface of the insulating sheet 620 that faces (e.g., faces away from) the first surface of the insulating sheet 620. For example, the insulating sheet 620 may be configured to be provided between the first swelling layer 610_1 and the second swelling layer 610_2. In some embodiments, the swelling member 600 may have stiffness/strength due to the insulating sheet 620 while having high cushioning capability due to the swelling layers 610 disposed on opposite sides.

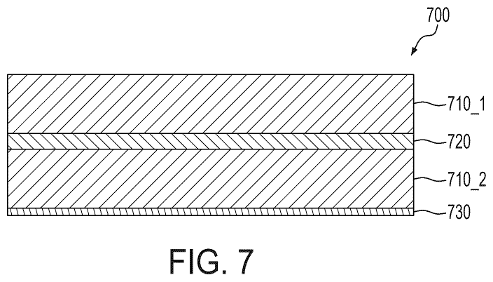

FIG. 7 illustrates an example of a swelling member 700 according to a fifth embodiment of the present disclosure. The swelling member 700 may include a first swelling layer 710_1 capable of swelling by impregnation with electrolyte, an insulating sheet 720 (e.g., an electrically insulating sheet 720), a second swelling layer 710_2 capable of swelling by impregnation with electrolyte, and an adhesive layer 730. The swelling member 700 may be substantially the same as the swelling member 600 of FIG. 6, except that the swelling member 700 further includes the adhesive layer 730. In FIG. 7, the structure of the adhesive layer 730, which is not present in the swelling member 600 of FIG. 6, will be mainly described.

Referring to FIG. 7, the adhesive layer 730 may be on a first surface of the second swelling layer 710_2. In some embodiments, the first surface of the second swelling layer 710_2 on which the adhesive layer 730 is provided may be different from the first surface of the second swelling layer 710_2 on which the insulating sheet 720 is provided. However, the foregoing is not intended to be limiting, and the adhesive layer 730 may be on the first surface of the first swelling layer 710_1. In another example, the adhesive layer 730 may be on side surfaces of the first swelling layer 710_1, the insulating sheet 720, and the second swelling layer 710_2. In some embodiments, the swelling member 700 may obtain stiffness/strength due to the insulating sheet 720, have enhanced cushioning capability due to the swelling layers 710 on opposite sides, and be fixed inside the secondary battery due to the adhesive layer 730.

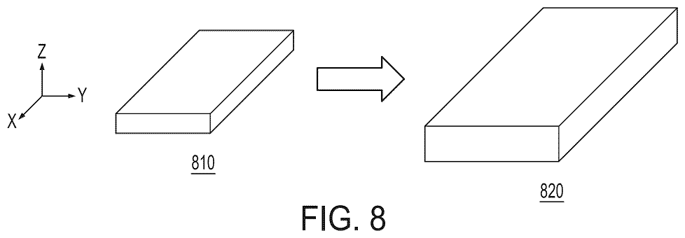

FIG. 8 illustrates example shapes of the swelling member according to embodiments of the present disclosure before and after being impregnated with electrolyte. The swelling member may include a swelling layer capable of swelling by impregnation with electrolyte. A first example 810 may represent a shape of the swelling member before electrolyte impregnation. A second example 820 may represent a shape of the swelling member after electrolyte impregnation. The first example 810 and the second example 820 show that the swelling member is swollen by impregnation with electrolyte.

In one embodiment, the swelling member may expand by 5% to 50% in volume after electrolyte impregnation than before electrolyte impregnation (e.g., compared to a volume of the swelling member before electrolyte impregnation). In another example, the swelling member may expand in thickness by 5% or more after electrolyte impregnation than before electrolyte impregnation (e.g., compared to a volume of the swelling member before electrolyte impregnation). As the swelling member expands to the above-described degree of volume and/or thickness, the swelling member may act as a buffer between the components within the secondary battery and act as a suitable insulating structure (e.g., electrically insulating structure) between the components within the secondary battery.

Table 1 below shows the experimental results of measuring swelling amounts and drop test pass rates before and after electrolyte impregnation of Comparative Examples and Examples.

TABLE 1

| | swelling | | | | | | Drop Test |
|---|---|---|---|---|---|---|---|
| | Layer | Insulating | Adhesive | Additive | | Expansion | Pass Rate |
| | Material | Sheet | Layer | Material | Particulate | (%) | (%) |
| Comp. | PET | X | X | X | X | <1 | 80 |
| Ex. 1 | | | | | | | |
| Comp. | PET | X | X | Al₂O₃ | X | <1 | 90 |
| Ex. 2 | | | | (10 wt %) | | | |
| Example | PVDF-HFP | X | X | Al₂O₃ | X | 3 | 85 |
| 1 | (1 mol %) | | | (10 wt %) | | | |
| Example | PVDF-HFP | X | X | Al₂O₃ | X | 16 | 95 |
| 2 | (5 mol %) | | | (10 wt %) | | | |
| Example | PVDF-HFP | X | X | Al₂O₃ | X | 41 | 100 |
| 3 | (10 mol %) | | | (10 wt %) | | | |
| Example | PVDF-HFP | X | X | Al₂O₃ | X | 61 | 85 |
| 4 | (15 mol %) | | | (10 wt %) | | | |
| Example | PVDF-HFP | X | X | X | X | 43 | 95 |
| 5 | (10 mol %) | | | | | | |
| Example | PVDF-HFP | X | X | bohemite | X | 42 | 100 |
| 6 | (10 mol %) | | | (10 wt %) | | | |
| Example | PVDF-HFP | X | X | X | ◯ | 47 | 85 |
| 7 | (10 mol %) | | | | | | |
| Example | PVDF-HFP | X | X | Al₂O₃ | X | 48 | 95 |
| 8 | (10 mol %) | | | (5 wt %) | | | |
| Example | PVDF-HFP | X | X | Al₂O₃ | X | 39 | 100 |
| 9 | (10 mol %) | | | (15 wt %) | | | |
| Example | PVDF-HFP | X | X | Al₂O₃ | X | 36 | 100 |
| 10 | (10 mol %) | | | (20 wt %) | | | |
| Example | PVDF-HFP | X | ◯ | Al₂O₃ | X | 41 | 100 |
| 11 | (10 mol %) | | | (10 wt %) | | | |
| Example | PVDF-HFP | ◯ | X | Al₂O₃ | X | 31 | 100 |
| 12 | (10 mol %) | | | (10 wt %) | | | |
| Example | PVDF | X | X | Al₂O₃ | X | 2 | 85 |
| 13 | | | | (10 wt %) | | | |
| Example | PVDF-CTFE | X | X | Al₂O₃ | X | 40 | 100 |
| 14 | (10 mol %) | | | (10 wt %) | | | |
| Example | PVDF-TFE | X | X | Al₂O₃ | X | 34 | 100 |
| 15 | (10 mol %) | | | (10 wt %) | | | |
| Example | Urethane | X | X | Al₂O₃ | X | 32 | 100 |
| 16 | | | | (10 wt %) | | | |

In Table 1, the “Swelling Layer Material” column may refer to materials contained in the swelling layer. Any numerical value in parentheses described with the material may refer to the amount of comonomer added during PVDF polymerization. The “Additive Material” column may refer to the material of the additive contained in the swelling layer. Any numerical value in parentheses described with the material may refer to the added amount of the additive.

An Example related to PVDF includes a homopolymer of vinylidene difluoride (VDF). An Example related to PVDF-HFP includes a copolymer of VDF and HFP, wherein HFP is a comonomer. An Example related to PVDF-CTFE includes a copolymer of VDF and chlorotrifluoroethylene (CTFE), wherein CTFE is a comonomer. An Example related to PVDF-TFE includes a copolymer of VDF and tetrafluoroethylene (TFE), wherein TFE is a comonomer.

PVDF-based polymers were obtained by suspension polymerization of VDF and a comonomer. The synthesized polymer was formed into a film through extrusion molding. The formed film was punched to a predetermined size to form a swelling member. In an Example including an additive, the additive was added to the synthesized polymer, which was then formed into a film through extrusion molding. In an Example including an adhesive layer, an adhesive solution was applied to the film formed by extrusion molding, and the solvent was dried to form the adhesive layer. In an Example including an insulating sheet, the insulating sheet was attached to the film formed by extrusion molding and laminated.

Each of the Comparative Examples and Examples includes a material/structure as shown in Table 1. For example, Comparative Example 1 includes only a swelling layer including PET. In another example, Example 11 includes a swelling layer including PVDF-HFP (10 mol %) and an adhesive layer including aluminum oxide (10 wt %). In another example, Example 12 includes a swelling layer including PVDF-HFP (10 mol %) and an insulating sheet including aluminum oxide (10 wt %). An adhesive layer is included between the swelling layer and the insulating sheet to bond the swelling layer and the insulating sheet.

For each of the swelling members according to the Comparative Examples and Examples, the thickness before impregnation with the electrolyte was measured to be about 200 μm. However, the swelling member according to Example 12 was measured to be slightly more than 200 μm. For example, the swelling member according to Example 12 included a swelling layer having a thickness of 150 μm and a 50 μm insulating sheet, and an adhesive layer is formed between the swelling layer and the insulating sheet. The thicknesses of the adhesive layers included in Examples 11 and 12 were measured to be about 5 μm.

The amount of expansion before and after electrolyte impregnation was determined for a secondary battery comprising a swelling member according to a Comparative Example or an Example. In this case, the dimensions of the secondary battery case were a width of 60 mm, a thickness of 4.5 mm, and a height of 70 mm. The thickness of the swelling member for the Comparative Examples and the Examples was 4.3 mm. The dimensions of the electrode assembly were a width of 60 mm, a thickness of 4.3 mm, and a height of 69 mm.

In Table 1, the “Expansion” column may refer to the amount of expansion, e.g., the degree to which the swelling member expanded after electrolyte impregnation relative to the swelling member before electrolyte impregnation. Specifically, the amount of expansion may be calculated by the numerical expression: (thickness of expanded swelling member-thickness of swelling member before expansion)/(thickness of swelling member before expansion). In this manner, it is possible to determine the degree to which the swelling member has expanded after electrolyte impregnation, and to determine the extent to which the swelling member may perform a buffering function within the secondary battery.

In addition, the “Drop Test Pass Rate” column may refer to a pass rate measured by repeatedly dropping a secondary battery including a swelling member. For example, if the drop test pass rate is greater than or equal to 95%, the secondary battery including the swelling member may be determined to be safe for drops. Specifically, a drop test was performed on 20 secondary batteries including a swelling member according to a Comparative Example or an Example. The drop test included 18 drop cycles, with a single cycle including 18 drops from a height of 1.8 meters. Secondary batteries subjected to the drop test were able to pass if the open circuit voltage (OCV) remained equal to or below 50 mV after 120 hours and there was no sparking/ignition. In this manner, it is possible to determine whether the secondary battery including the swelling member may withstand the impact being dropped and remain safe even if dropped.

Referring to Table 1, it may be seen that the secondary battery including the swelling member according to each of Comparative Examples respectively has a drop test pass rate of less than 95%. The secondary battery including the swelling member according to each of Examples excluding Examples 1, 4, 7, and 13 was observed to have a drop test pass rate of more than 95% in the test. For example, according to most Examples, the secondary battery including the swelling member was determined to be safe against drops.

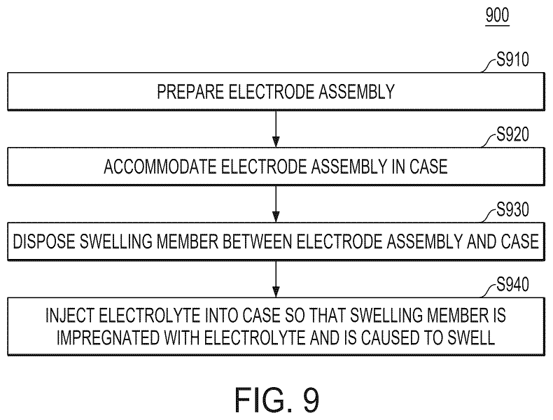

FIG. 9 is a flowchart 900 showing an example of a method of manufacturing a secondary battery according to embodiments of the present disclosure. A secondary battery manufacturing apparatus may be an apparatus for manufacturing the secondary battery according to embodiments of the present disclosure.

In one embodiment, method of manufacturing a secondary battery may begin by preparing an electrode assembly by the secondary battery manufacturing apparatus in S910.

The secondary battery manufacturing apparatus may accommodate the electrode assembly in a case in S920.

The secondary battery manufacturing apparatus may provide or patch a swelling member between the electrode assembly and the case in S930. For example, an electrode tab of the electrode assembly may be formed on a first side of the electrode assembly and connected to an electrode of the electrode assembly, a first side surface of the case may be connected to the electrode tab, and the swelling member may be provided between the first side of the electrode assembly and the first side surface of the case. In some embodiments, the swelling member may insulate (e.g., electrically insulate) between the electrode tab and the electrode assembly and/or between the electrode assembly and the case.

The secondary battery manufacturing apparatus may inject electrolyte into the case so that the swelling member is impregnated with the electrolyte and is caused to swell in S940. In some embodiments, the swelling member may be configured to fill a peripheral space between the case and the electrode assembly within the case, and may include a first swelling layer capable of swelling by impregnation with electrolyte. For example, the swelling member may have a corrugated shape.

In one embodiment, the swelling member may expand in volume by 5% to 50% after electrolyte impregnation than before electrolyte impregnation (e.g., compared to a volume of the swelling member before electrolyte impregnation). In some embodiments, the swelling member may expand in thickness by more than 5% after electrolyte impregnation than before electrolyte impregnation (e.g., compared to a thickness of the swelling member before electrolyte impregnation).

In one or more embodiments, the first swelling layer may include at least one of a fluorine-based resin or a urethane-based resin. For example, the fluorine-based resin may comprise a polyvinylidene difluoride (PVDF) copolymer. For example, the PVDF copolymer may include at least one of polyvinylidene difluoride-hexafluoropropylene (PVDF-HFP), polyvinylidene difluoride-perfluoroalkoxy (PVDF-PFA), polyvinylidene difluoride-chlorotrifluoroethylene (PVDF-CTFE), or polyvinylidene difluoride-tetrafluoroethylene (PVDF-TFE).

In one or more embodiments, the first swelling layer may further include an additive having heat-absorbing properties. The additive may include at least one of aluminum oxide (Al₂O₃) or boehmite. In one embodiment, the first swelling layer may further include particulates including an acrylic-based resin.

In one or more embodiments, the swelling member further includes an adhesive layer on a first surface of the first swelling layer, and the swelling member may be bonded to at least one of the electrode assembly or the case by the adhesive layer.

In one embodiment, the swelling member further includes an insulating sheet (e.g., an electrically insulating sheet) on the first surface of the first swelling layer, wherein the insulating sheet may include at least one of polyethylene terephthalate (PET), polybutylene terephthalate (PBT), polyimide (PI), or polyether ether ketone (PEEK). In some embodiments, the first swelling layer may be on a first surface of the insulating sheet, and the swelling member may further include a second swelling layer on a second surface of the insulating sheet opposite (e.g., facing away from) the first surface of the insulating sheet.

The flowchart of FIG. 9 and the above description are only illustrative of embodiments of the present disclosure, but the scope of the present disclosure is not limited to the flowchart of FIG. 9 and the above description. For example, one or more of the steps in the flowchart and the above description may be added/altered/deleted, the order of one or more of the steps may be changed, and one or more of the steps may be performed concurrently (e.g., simultaneously).

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A secondary battery comprising:
an electrode assembly;
a case that accommodates the electrode assembly; and
a swelling member between the electrode assembly and the case,
wherein the swelling member that fills a peripheral space between the case and the electrode assembly within the case, and comprises a first swelling layer capable of swelling by impregnation with electrolyte.

2. The secondary battery as claimed in claim 1, wherein the electrode assembly comprises an electrode tab on a first side of the electrode assembly and connected to an electrode of the electrode assembly,
wherein a first side surface of the case is connected to the electrode tab, and
wherein the swelling member is between the first side of the electrode assembly and the first side surface of the case.

3. The secondary battery as claimed in claim 2, wherein the swelling member insulates at least one of a space between the electrode tab and the electrode assembly or a space between the electrode assembly and the case.

4. The secondary battery as claimed in claim 1, wherein the swelling member expands by 5% to 50% in volume after the impregnation with electrolyte compared to a volume of the swelling member before the impregnation with the electrolyte.

5. The secondary battery as claimed in claim 1, wherein the swelling member expands by 5% or more in thickness after impregnation with the electrolyte compared to a thickness of the swelling member before impregnation with the electrolyte.

6. The secondary battery as claimed in claim 1, wherein the first swelling layer comprises at least one of a fluorine-based resin or a urethane-based resin.

7. The secondary battery as claimed in claim 6, wherein the fluorine-based resin comprises a polyvinylidene difluoride (PVDF) copolymer.

8. The secondary battery as claimed in claim 7, wherein the PVDF copolymer comprises at least one of polyvinylidene difluoride-hexafluoropropylene (PVDF-HFP), polyvinylidene difluoride-perfluoroalkoxy (PVDF-PFA), polyvinylidene difluoride-chlorotrifluoroethylene (PVDF-CTFE), or polyvinylidene difluoride-tetrafluoroethylene (PVDF-TFE).

9. The secondary battery as claimed in claim 6, wherein the first swelling layer further comprises an additive having heat-absorbing properties.

10. The secondary battery as claimed in claim 9, wherein the additive comprises at least one of aluminum oxide (Al₂O₃) or boehmite.

11. The secondary battery as claimed in claim 6, wherein the first swelling layer further comprises particulates comprising an acrylic-based resin.

12. The secondary battery as claimed in claim 1, wherein the swelling member further comprises an adhesive layer on a first surface of the first swelling layer, and
the swelling member is bonded to at least one of the electrode assembly or the case by the adhesive layer.

13. The secondary battery as claimed in claim 1, wherein the swelling member further comprises an insulating sheet on a first surface of the first swelling layer, and
the insulating sheet comprises at least one of polyethylene terephthalate (PET), polybutylene terephthalate (PBT), polyimide (PI), or polyether ether ketone (PEEK).

14. The secondary battery as claimed in claim 13, wherein the first swelling layer is on a first surface of the insulating sheet, and
the swelling member further comprises a second swelling layer on a second surface of the insulating sheet opposite the first surface of the insulating sheet.

15. The secondary battery as claimed in claim 1, wherein the swelling member has a corrugated shape.

16. A method of manufacturing a secondary battery, the method comprising:
preparing an electrode assembly;
accommodating the electrode assembly in a case; and
providing a swelling member between the electrode assembly and the case,
wherein the swelling member fills a peripheral space between the case and the electrode assembly within the case, and comprises a first swelling layer capable of swelling by impregnation with electrolyte.

17. The method as claimed in claim 16, further comprising injecting an electrolyte into the case so that the swelling member is impregnated with the electrolyte and is caused to swell.

18. The method as claimed in claim 16, wherein the swelling member expands by 5% or more in thickness after the impregnation with electrolyte compared to a thickness of the swelling member before the impregnation with the electrolyte.

19. The method as claimed in claim 16, wherein the swelling member further comprises an insulating sheet on a first surface of the first swelling layer, and
the insulating sheet comprises at least one of polyethylene terephthalate (PET), polybutylene terephthalate (PBT), polyimide (PI), or polyether ether ketone (PEEK).

20. The method as claimed in claim 16, wherein the first swelling layer is on a first surface of the insulating sheet, and
the swelling member further comprises a second swelling layer on a second surface of the insulating sheet opposite the first surface of the insulating sheet.
